(19) United States
(12) Patent Application Publication
(10) Pub. No.: US 2004/0131928 A1
(43) Pub. Date: Jul. 8, 2004

(54) Modifying surfaces of devices to integrate them into wireless charging systems

(76) Inventors: Tal Dayan, Los Gatos, CA (US); Pandurangan Ramakrishnan, Palo Alto, CA (US); Dan Kikinis, Saratoga, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/667,016

(22) Filed: Sep. 17, 2003

Related U.S. Application Data
(60) Provisional application No. 60/411,566, filed on Sep. 17, 2002.
(60) Provisional application No. 60/413,791, filed on Sep. 25, 2002.

(51) Int. Cl. H01M 2/10

(52) U.S. Cl. 429/123; 429/96

(57) ABSTRACT

A mobile electronic apparatus, including a replacement unit to be fitted with the apparatus, the replacement unit including integrated external electrically conductive contacts to receive power from a separate pad of multiple contacts.

This application claims priority to provisional application No. 60/411,566 titled “Modifying Surfaces of Devices to Integrate Them Into Wireless Charging Systems” filed Sep. 17, 2002 (attorney docket no. 6041.P008z) and to provisional application No. 60/413,791 titled “Enhanced Contact Systems For Surfaces and Devices” filed Sep. 25, 2002 (attorney docket no. 6041.P009z) and incorporates both applications herein by reference, and also incorporates the respective attachments to the provisional applications.

### BACKGROUND

Very often an existing portable device needs to be upgraded to support wireless power. However, gluing contacts on the outside may not always be suitable, for various reasons. For one reason, the contacts may be torn off easily from a device such as, for example, a notebook computer, which is pushed in and pulled out of a carrying case frequently, where the contacts may easily catch on the zipper, etc. For yet another reason, some devices may have a pronounced curve to their external plastic surfaces, which may reduce that ability to make a proper connection or easy gluing of an add-on solution.

FIG. 1 shows an example in current art of a cell phone 100 that has a removable battery pack 111. The battery pack is attached to the outside enclosure of the phone, as shown by dotted line 101. The battery pack has a latch 112 that hooks into a slot 102 on the cell phone to facilitate removal of the pack and attachment of the pack to the phone. Typically, such a battery pack has at least two contacts, shown here as contacts 113a-n on the pack, that match with a set of contacts 103a-n on the phone when the battery pack is attached to the phone, as suggested by arrow 120.

FIG. 2 shows a similar system, but of the type where the battery and its enclosure are two separate parts. Again, the position of the battery when attached to the phone is shown by dotted line 101 in the outline of the phone 100. However, in this example, the battery 211 with contacts 113a-n is separate from the battery cover 221, which has a latch 212. The cover has to be put on after the battery is properly situated and connected. Depending on the system, the battery, rather than just having contacts, may have a short cable (not shown) with connectors that plug into a connector on the phone to secure the contacts. After the battery contacts are plugged into the phone contacts, then the cover 221 is put on over battery 211 in situ in phone 100.

What is clearly needed is a system wherein a battery pack, for example, or an enclosure of a battery pack, or an enclosure of a device may be replaced by one that has integrated contacts, thus avoiding the problems or providing a solution to the problems that would arise out of gluing on additional contacts. Furthermore, such or further additional contacts may be designed to allow powering of a second device in addition to the original, primary device.

In addition, the system discussed in co-pending provisional application titled “MODIFYING SURFACES OF DEVICES TO INTEGRATE THEM INTO WIRELESS CHARGING SYSTEMS”, Attorney Docket No. 6041.P008z, filed Sep. 17, 2002, and the co-pending applications referenced therein, herein incorporated by reference, requires in some cases that the contacts on the device and its corresponding surface must have a satisfactory contact. In addition, if a device has more than three legs there is, at least theoretically, the chance that one of the legs may not touch. If said non-contacting leg is a contact leg, the non-contact may likely result in a malfunction of the system.

What is also clearly needed is a system with a mechanism that by spring-loading or other means allows the contacts to have additional freedom of movement to improve the chances of proper contact between the leg and the matching area on the corresponding surface.

### BRIEF DESCRIPTION OF THE DRAWINGS

FIG. 1 illustrates an example in current art of a cell phone that has a removable battery pack.

FIG. 2 illustrates an example of a cell phone that has a removable battery pack where the battery and its enclosure are two separate parts.

FIG. 3 illustrates a phone of the style shown in FIG. 1 with multiple alternatives in accordance with one embodiment.

FIG. 4 illustrates an approach for a battery pack that has a separate cover accordance with one embodiment.

FIG. 5 illustrates an alternative approach, for a notebook computer according to one embodiment.

FIG. 6 illustrates the bottom of a device 100, which could, for example, be a PDA or notebook in accordance with one embodiment.

FIG. 7 illustrates a cross section AA of a standard rubber foot in more detail.

FIG. 8 illustrates a cross section BB of the enhanced foot according to one embodiment.

FIG. 9 illustrates an enhanced method for low-cost manufacturing of the conductive pad according to one embodiment.

FIG. 10 illustrates a side view of the same stainless steel sheet section according to one embodiment.

FIG. 11 illustrates a small section with one contact of the sheet according to one embodiment.

FIG. 12 illustrates the resulting pad according to one embodiment.

FIGS. 13a-c illustrate the use varying number of feet according to one embodiment.

### DESCRIPTION OF THE EMBODIMENT

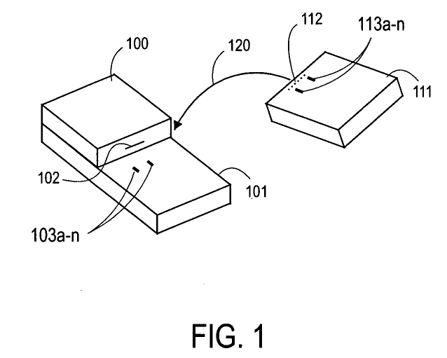

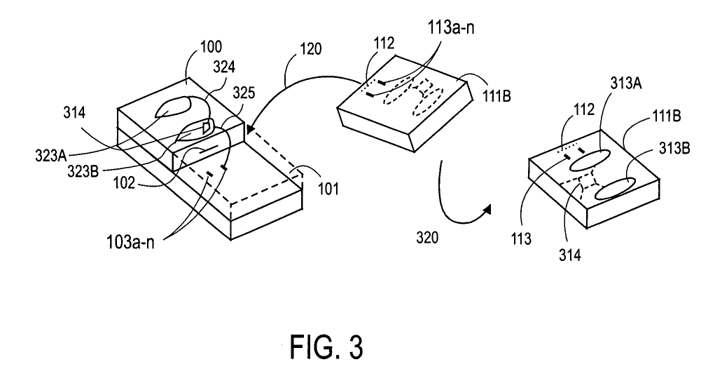

FIG. 3 shows a phone of the style shown in FIG. 1, but with multiple alternatives of the novel art of this disclosure. For example, battery pack 111b has been changed to contain an active area 320, as described in previous co-pending applications, herein incorporated by reference. Pack 111b shows the battery pack flipped upside down, so now the contacts 313a and 313b are visible, as well as a dotted line that indicates the control circuitry 314 that has been added inside the battery pack. Even though the example discussed is a cell phone, essentially the same applies for all kinds of portable electronic, including, but not limited to cell phones, notebooks, PDA's, still and video cameras, portable video and audio players, any hybrid combinations and other mobile, not yet conceived devices etc.

Often battery packs already contain some circuitry, so rather than a separate add-on, additional new circuitry could be simply integrated into the internal circuitry of the battery pack, such as in area 320. Therefore, the phone would not “see” any change in its electrical capabilities. Some batteries in current art already have external contacts that allow the battery to be charged from the outside while the phone is, for example, in a cradle in a car or on a desktop. Those external contacts could be used for the activities of the novel art of this disclosure as well by extending the contact sizes to match the requirements of the upgraded system.

Those additional shell parts, batteries, contact sets and wires may be sold as upgrades, much like faceplates for phones are sold today in retail stores, often as an after market module. In some cases however, the changes, upgrades and additions may pertain to other subsets of a system than just shell or battery, including but not limited to memory card, CD player, other attachable peripherals, etc.

Additionally, on the phone body 100 itself the top portion of the cover may be removed and replaced with a cover that has integrated contacts such as contacts 323a and 323b. Circuitry 314 could be hidden under contact 323b, and a connection to the phone 100 could be established through wires 324 and 325. Similar replacements are made today for purposes of cosmetic upgrades to cell phones. For example, in many cell phones the face plate can be changed, and for some cell phones, kits are available to add lighting effects to such a cosmetic cover, including a wire that is inserted between the phone and the battery to power the LEDs that generate the lighting effects. Wire 325 may be connected in a similar way to interface between the phone 100 and the battery 111b. If such modifications are introduced, the cover could in some cases for example, have contacts that allow a second phone or other, similar device to be powered while the primary battery is charged.

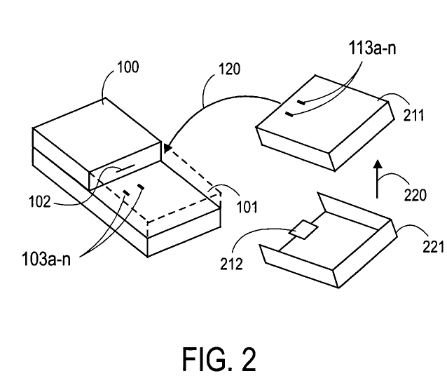

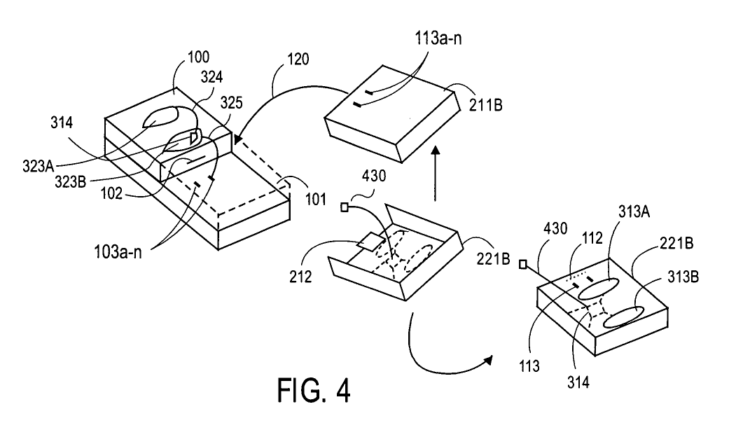

FIG. 4 shows an approach for a battery pack that has a separate cover, as previously shown in FIG. 2. The novel art is similar to that described for FIG. 3, above; however, because the batteries in this situation often have wires, the battery may be, for example, plugged into circuitry 314, which is contained in battery cover 221b (221b from the other view). That circuitry would then have a wire 430 that connects to the phone instead of a wire or wires from the battery (not shown). In other cases where the battery doesn't have its own wire, a wire may be inserted between the battery and the phone to properly connect and be able to charge the battery and power the phone.

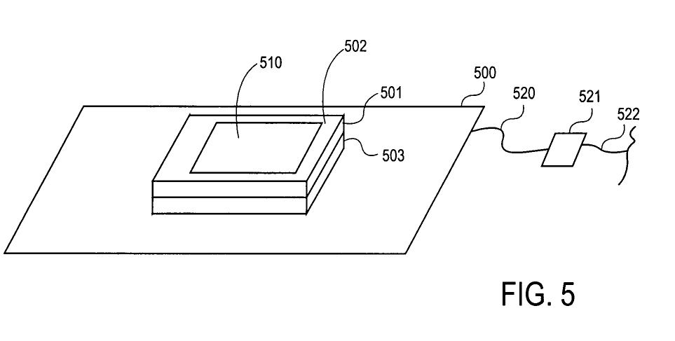

FIG. 5 shows another approach, for a notebook computer. It is a further elaboration of the case discussed above, where contacts are added to the case or shell, allowing a second device to be charged and or powered. In this example, notebook 501 typically has a base side 503 and a lid 502 that can be flipped up. It stands on active surface 500, which is connected via cable 520 to power supply 521, which in turn is connected through wire 522 to main ac power. On the top of lid 502, the outer covering has been replaced to contain an active area 510, as described in previous co-pending applications, where devices such as a couple of cell phones, PDAs, or other, similar devices may be charged. The control circuitry may be included in the device, such as the notebook, or in other cases, the contacts offered may just be a pass thru, and control comes from the main control unit of the main pad, surface etc.

As discussed earlier, other methods than direct contact may be used, such as the other wire free charging methods (induction, RF, capacitive etc), and those components may be integrated in a similar analogous manner into replacement shells etc.

When replacing the battery and or the shell or components thereof, mechanical changes to the original design may be made. For example, the new battery can be larger to contain room for necessary electronics, elongated to touch an existing power input contactor or the shell may have a different shape (e.g. flat) than the original.

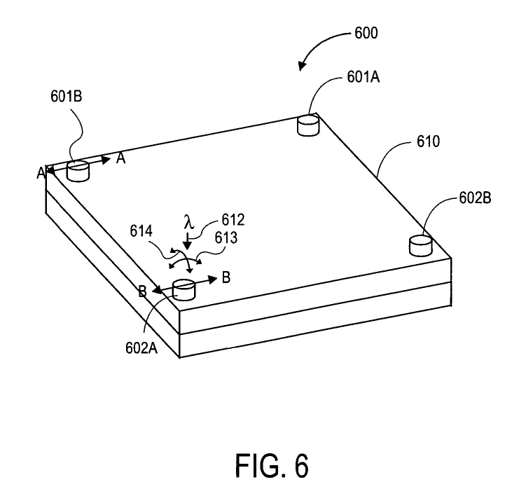

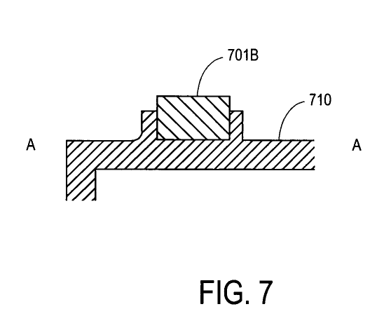

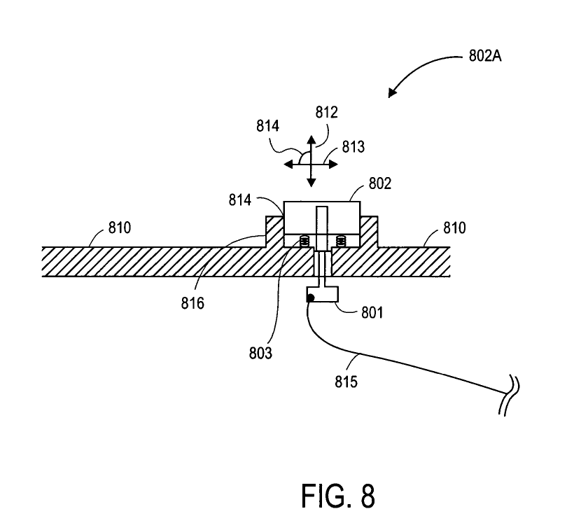

FIG. 6 shows the bottom of a device 600, which could, for example, be a PDA or notebook. The bottom case shell 610 of device 600 has standard rubber feet 601a and 601b. It has also two special contact feet 602a and 602b. A cross section AA of a standard rubber foot 601b is shown in more detail in FIG. 7, and a cross section BB of the enhanced foot according to the novel art of this disclosure is shown in FIG. 8. It is important to the novel art of this disclosure that feet 602a and 602b have additional freedom in their range of motion so they can move forward and backward as indicated by motion arrow 614, left and right as indicated by motion arrow 613, and vertically as indicated by motion arrow 612. The range of motion indicated by motion arrow 612 is the most important, to guarantee that all four legs, and in particular contact legs 602a and 602b, properly contact the required areas of the corresponding surface.

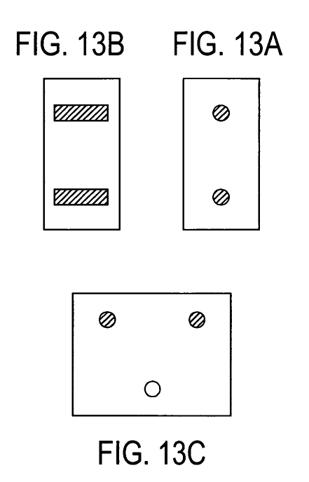

In some cases, a unit may, as shown in FIG. 13, use only two feet (both conductive), as shown in FIG. 13a and FIG. 13b, or three feet (at least two of which are conductive), as shown in FIG. 13c, such that the two conductive feet (indicated by shading in the outline of the feet in FIG. 13c) are guaranteed to touch the surface, eliminating the need for flexibility in the z axis.

FIG. 7 shows the cross section AA of a standard rubber foot 701b. Typically a holding form or shape is molded into the shell 710. A rubber foot cutout in a matching format 701b is inserted and typically secured with glue (not shown). In some designs, other methods of securing the foot to the shell may be employed, such as pins, screws, stakes, wedges, notches, etc.

FIG. 8 shows a cross section BB of foot 802a, with motion arrows 812, 813, and 814 showing the range of motion. It is important to the novel art of this disclosure that bottom shell 810 has a holding shape 816 molded to it. Conductive foot material forms a disk 802, which in this example is held back by a bolt 801 and is spring-loaded by spring 803. In other designs, a foam material, for example, may be used instead of a spring. This arrangement allows the required freedom of range of motion indicated by arrows 812, 813, and 814. A gap 814 between the conductive foot 802 and the retainer ring 816 (holding shape) provides space for horizontal range of motion in all directions; while the spring extension 803 provides space for the required vertical range of motion by pushing the bolt head 801 into the device. Also important is wire 815, which connects to bolt 801 and delivers the electricity to the circuitry inside the device (not shown).

Various modifications to the details of this design may be made; for example, multiple springs may be used instead of one spring, or multiple bolts may be used instead of one bolt. Also, the shape of the foot may be triangular, square, elliptic, or any other shape, instead of just round.

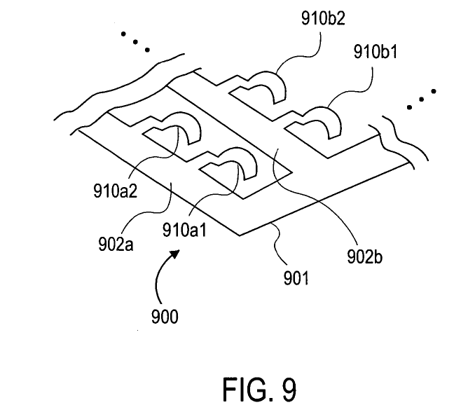

FIG. 9 shows an enhanced method for low-cost manufacturing of the conductive pad. A small section 900 has four contacts. The pad, depending on its design, may have multiple sections, each with multiple contacts. These contacts may be stamped from a sheet of slightly springy steel 900. There is a cross-connect 901 between the rows and the rows 902a, 902b, etc. In each row is a number of contacts, such as 910a1, 910a2, etc., and 910b1, 910b2, etc. Depending on the size of the total pad, there may be a more, even many more, sections 900, and each section may have its own set of connected contacts, where as neighboring sections are isolated from one another and connect to the controller as described in the earlier applications.

In other cases, the sheet metal may have many other shapes, such as, for example, stamped bumps instead of raised flaps. Also, it may be made of separate pins or rivets that are inserted into the metal sheet, as long as parts of the metal are exposed in the top layer or protrude from it. In yet other cases, the sheet metal may be molded into the plastic or the plastic may be molded separately and then the metal contacts may be inserted into the plastic. Also, the exposed metal contacts may form an aesthetic pattern, have any of various different sizes and shapes, etc.

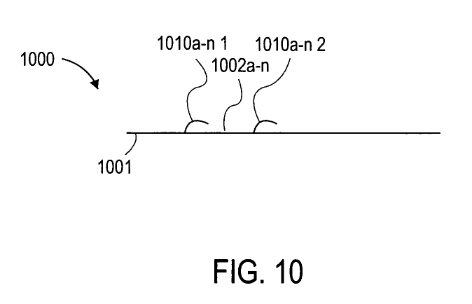

FIG. 10 shows a side view of the same stainless steel sheet section 1000. Cross-connect 1001 is at the end and members 1002a-n (all one behind another) are going across, and contacts 1010a-n1, 1010a-n2, etc., are distributed along. Since all contacts in a section line up, they cannot be seen individually.

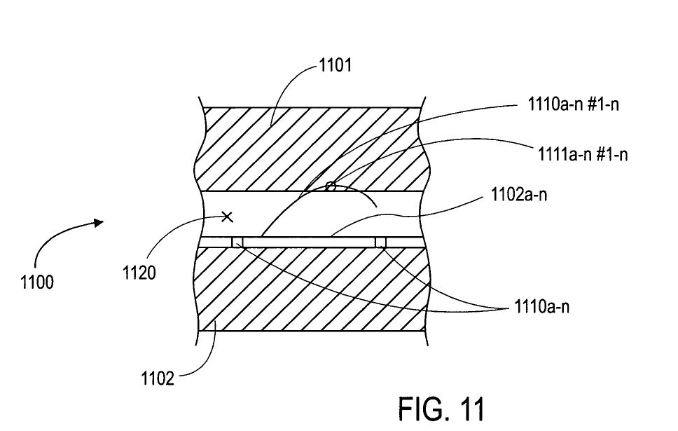

FIG. 11 shows a small section with one contact of the sheet 1100 in a mold. Cross member 1102a-n rests on distance pins 1110a-n, which are strategically placed throughout the mold. Spring contacts 1110a-n #1-n touch the upper side of the mold at contact points 1111a-n #1-n. Depending on the design, there may be a slight cavity, which will result in a slight protrusion of the contact after the injection is finished.

Cavity 1120 is then injected with a specified material. According to the design specifications, the material may be slightly rubbery or somewhat flexible, and it may vary in colors and textures. Cross section 1101 is the mold top and cross-section 1102 is the mold bottom.

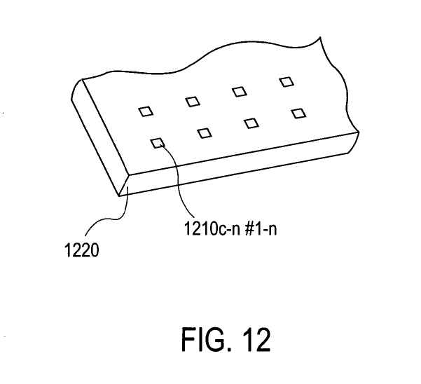

FIG. 12 shows the resulting pad 1220. The thickness of pad 1220 matches the opening of the cavity 1220 in FIG. 11. Surfaces 1210a-n #1-n protrude on the top side, thus allowing for connection with feet of devices as discussed earlier.

Not shown, for reasons of simplicity and clarity, is the wiring that connects each section of spring steel insert to the controller and power supply of the device, as discussed in previous co-pending applications. Depending on the number of contact zones, multiple wires may be embedded in the mold, and the mold may have provisions for holding said wires in place during the injection process. In some cases the wiring may be done by having an extended steel frame, similar to the lead frame used in the manufacturing of integrated circuits, rather than attaching wires individually. All the wires carried by those extended lead frames could then terminate at one connector at the side of the finished pad, and could there be connected to a controller and/or a power supply, as described earlier.

Typically the spring metal sheets could be loaded into the mold either manually or automatically. They would then be secured in a certain position with pins such as 610a-n. Those pins may have additional features, such as a protruding smaller pin fitting into a hole in the spring sheet, to ensure absolute, precise positioning. Additional pins may be provided to hold wiring down while the plastic flows into the mold.

It is clear that many modifications and variations of this embodiment may be made by one skilled in the art without departing from the spirit of the novel art of this disclosure.

The cost advantage of this design is that stamping the steel contacts should result in lower manufacturing costs.

1) A mobile electronic apparatus comprising:
a replacement unit to be fitted with the apparatus, the replacement unit including integrated external electrical contacts to receive power from a separate pad of contacts.

2) The mobile apparatus of claim 1, wherein the replacement unit is a battery pack.

3) The mobile apparatus of claim 1, wherein the replacement unit is a face plate.

4) The mobile apparatus of claim 1, wherein the mobile apparatus is a mobile phone.

5) The mobile apparatus of claim 1, wherein the mobile apparatus is a mobile computer, including a notebook computer.

6) The mobile apparatus of claim 1, wherein the mobile apparatus is a personal digital assistant.

7) The mobile apparatus of claim 1, wherein the mobile apparatus is a digital camera.

8) The mobile apparatus of claim 1, wherein the mobile apparatus is a video camera.

9) The mobile apparatus of claim 1, wherein the extermobile apparatus is a mobile phone.

10) A mobile electronic apparatus comprising:
one or more external electrically conductive contact to receive power from a separate pad of multiple contacts, the contact being spring loaded to provide the contact with a range of motion.

11) The mobile apparatus of claim 10, wherein the contact is moveable in a vertical direction relative to the apparatus.

12) The mobile apparatus of claim 10, wherein the contact is moveable in a horizontal direction relative to the apparatus.

13) The mobile apparatus of claim 10, wherein the contact is moveable in a perpendicular direction relative to the apparatus.
